(19) United States
(12) Patent Application Publication
(10) Pub. No.: US 2005/0111633 A1
(43) Pub. Date: May 26, 2005

(54) System and method for voice enabled information retrieval

(76) Inventor: Jason T. Osborne, Aurora, IL (US)

Correspondence Address: Blakely, Sokoloff, Taylor & Zafman LLP;Suite 101, 5285 S.W. Meadows Road, Lake Oswego, OR, 97035, US

(21) Appl. No.: 10/722,726

(22) Filed: Nov. 25, 2003

(51) Int. Cl. H04M 1/64

(52) U.S. Cl. 379/88.22; 379/88.17

(57) ABSTRACT

A method and system for allowing voice enabled information retrieval. A voice enabled information retrieval system inputs voice data that represents an information request from a user. The voice data travels to the voice enabled information retrieval system either via a PSTN or a wireless network. The voice enabled information retrieval system then performs speech recognition on the voice data, determines the search criteria (e.g., keywords) based on the speech recognition, searches a data network for appropriate contents based on the search criteria, extracts the contents most relevant to the search criteria and forwards the extracted contents to the user. These extracted contents are displayed to the user on a television via a set-top box in response to his or her requested information.

### BACKGROUND

The importance of the ability to access on-line information (e.g., via the Internet) cannot be overstated. This is especially true today where person to person customer service seems to be a thing of the past. The ability for most people to access on-line information with ease is assumed by the majority of information providers. Unfortunately, this is not always the case.

One common storage area for on-line information is the Internet. One method of accessing information on the Internet is known as the World Wide Web (www, or the “web”). The web is a distributed, hypermedia system, and functions as a client-server based information presentation system. Information that is intended to be accessible over the web is stored in the form of “pages” on general-purpose computers known as “servers.” The most common way for a user to access a web page is by using a personal computer (e.g., laptop computer, desktop computer, etc.), referred to as “client”, to specify the uniform resource locator (URL) of the page web for which he or she wishes to view.

There are many reasons why the use of a personal computer to access on-line information is not desireable. One reason is that the use of a personal computer to access on-line information is not possible if the user does not have access to such a computer. Additionally, not everyone has the ability or desire to use a personal computer to access on-line information. This lack of ability or desire could be due to the lack of skill in the use of a keyboard of the personal computer, the lack of knowledge on how the computer itself operates, the lack of knowledge on how to make a search or request for the desired information, and so forth. In the case where the on-line information needs to be retrieved quickly, there may be no time to wait for a computer to boot up, etc.

Many users are not good at determining the most relevant keywords or phases to conduct a search for on-line information in order to receive relevant responses to their requests. Here, it becomes frustrating when either the user has to review many non-relevant responses to his or her request or has to keep reexecuting the same request for information, but in a different way, until the appropriate results are returned.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for a voice enabled information retrieval system in which some embodiments of the present invention may operate;

FIG. 2 illustrates one embodiment of a voice enabled information retrieval system in which some embodiments of the present invention may operate;

FIG. 3 is a flow diagram of one embodiment of a process for allowing voice enabled information retrieval via a set-top box;

FIG. 4 is a flow diagram of one embodiment of a process for allowing the user to make an information request via a telephone (POTS);

FIG. 5 is a flow diagram of one embodiment of a process for allowing the user to make an information request via a mobile phone;

FIG. 6 is a flow diagram of one embodiment of a process for processing the user's information request to produce the requested information; and

FIG. 7 is a flow diagram of one embodiment of a process for displaying the requested information to the user.

### DESCRIPTION OF EMBODIMENTS

A method and system for allowing voice enabled information retrieval via a set-top box are described. In the following description, for purposes of explanation, numerous specific details are set forth. It will be apparent, however, to one skilled in the art that embodiments of the invention can be practiced without these specific details.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and hardware components.

Thus, a machine-readable medium may include any mechanism for storing or transmitting information in a form readable by a machine (e.g., a computer). These mechanisms include, but are not limited to, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments.

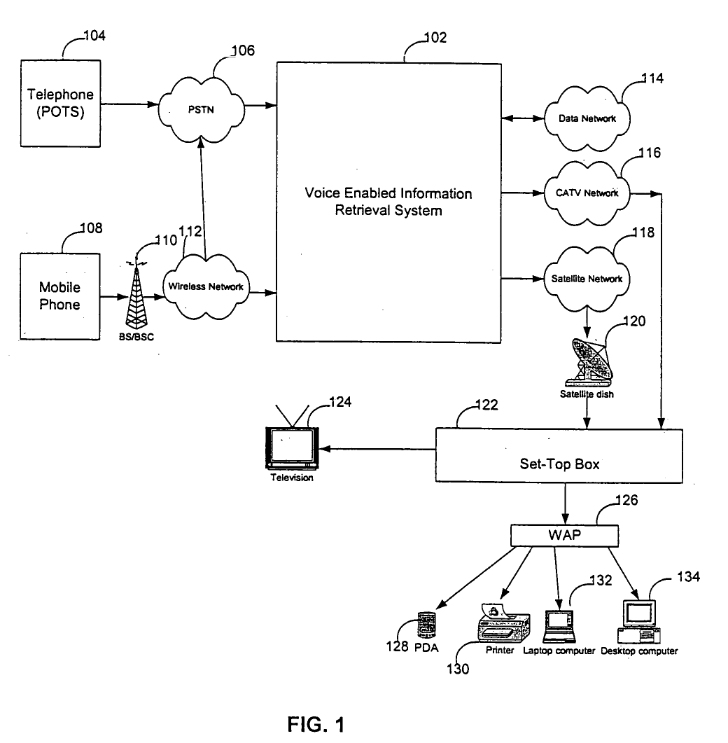

FIG. 1 illustrates one embodiment of an environment for a voice enabled information retrieval system, in which some embodiments of the present invention may operate. The specific components shown in FIG. 1 represent one example of a configuration that may be suitable for the invention and is not meant to limit the invention.

Referring to FIG. 1, the environment for a voice enabled information retrieval system includes, but is not necessarily limited to, a voice enabled information retrieval system 102, a telephone or plain old telephone system (POTS) 104, a public switched telephone system (PSTN) 106, a mobile phone 108, a base station/base station controller (BS/BSC) 110, a wireless network 112, a data network 114, a cable television (CATV) network 116, a satellite network 118, a satellite dish 120, a set-top box 122, a television 124, a wireless access point (WAP) 126, a personal digital assistant (PDA) 128, a printer 130, a laptop computer 132 and a desktop computer 134. Each of these components is described in more detail next.

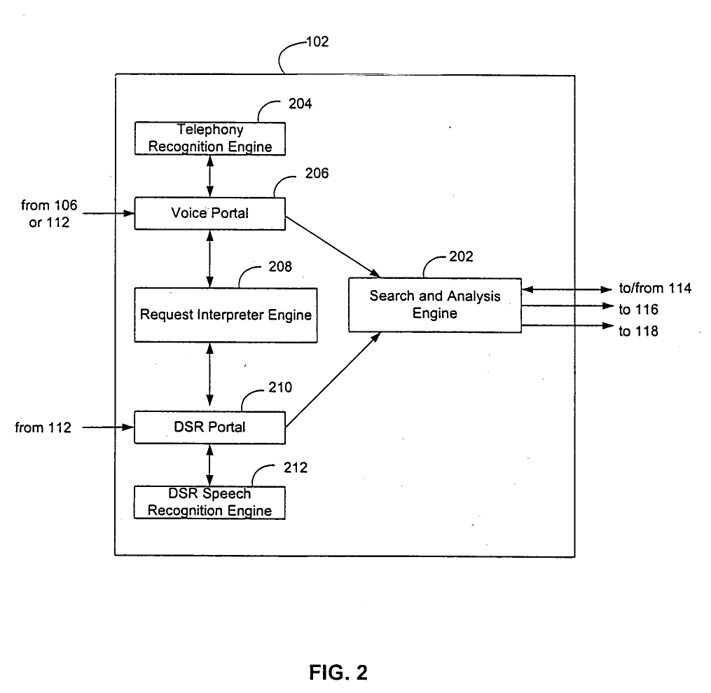

Voice enabled information retrieval system 102 inputs voice data that represents an information request from a user. As illustrated in FIG. 1, and in an embodiment of the invention, the voice data travels to system 102 either via PSTN 106 or wireless network 112, although the present invention is not limited to receiving voice data via these two types of networks. System 102 then performs speech recognition on the voice data, determines the search criteria (e.g., keywords) based on the speech recognition, searches data network 114 for appropriate contents based on the search criteria, extracts the contents most relevant to the search criteria and forwards the extracted contents to the user. These extracted contents are displayed to the user in response to his or her information request. The components of voice enabled information retrieval system 102 are described below with reference to FIG. 2.

As described above, voice enabled information retrieval system 102 receives voice data via either PSTN 106 or wireless network 112. In one embodiment of the invention, a user utilizes telephone 104 to dial a predetermined phone number and, when prompted, states his or her information request. This information request, or voice data, is sent via telephone 104 and PSTN 106 to voice enabled information retrieval system 102.

In another embodiment of the invention, the user utilizes mobile phone 108 to dial a predetermined phone number and, when prompted, states his or her information request. This information request, or voice data, is sent via mobile phone 108, BS/BSC 110 and wireless network 112 to voice enabled information retrieval system 102. The information request may also be sent via mobile phone 108, BS/BSC 110, wireless network 112 and PSTN 106 to voice enabled information retrieval system 102. As illustrated in FIG. 1, PSTN 106 and wireless network 112 are both coupled to voice enabled information retrieval system 102.

Voice enabled information retrieval system 102 is also coupled to data network 114 in FIG. 1. Data network 114 may be the Internet, a local area network (LAN), a wide area network (WAN), or any other searchable medium capable of storing on-line information. System 102 searches data network 114 for appropriate contents based on the search criteria of the user's information request.

Voice enabled information retrieval system 102 is also coupled in FIG. 1 to CATV network 116 and satellite network 118. Once system 102 determines the relevant contents to answer the user's information request, system 102 sends the relevant contents to the user either via CATV network 116 or satellite network 118. In the scenario where the relevant contents are sent to the user via satellite network 118, the relevant contents also go through satellite dish 120 before being sent to set-top box 122. In the scenario where the relevant contents are sent to the user via CATV network 116, the relevant contents are sent directly to set-top box 122.

Set-top box 122 may use either a conventional analog or digital television receiver as its display. In some embodiments, set-top box 122 sits on top of television 124. By combining the capabilities of a computer system and a television, set-top box 122 may provide advanced television programming features, such as an electronic programming guide, without requiring the user to incur any unnecessary costs for an additional monitor.

In one embodiment of the present invention, set-top box 122 includes at least one personal video recorder (PVR). PVR is a generic term for a device that is similar to a video cassette recorder (VCR) but records television data in digital format as opposed to the VCR's analog format. VCRs utilize analog tapes to record and play programs broadcast over television, but PVRs encode video data in MPEG-1 or MPEG-2 formats and store the data in a hard drive. PVRs may encode other types of data and other types of data may be added or substituted for those described as new types of data are developed and according to the particular application for the PVR. PVRs have all of the same functionality of VCRs (recording, playback, fast forwarding, rewinding, pausing, etc.) plus the ability to instantly jump to any part of the program without having to rewind or fast forward the data stream.

A typical PVR is made up of two elements, a device that stores its hardware elements (such as the hard disk drive, power supply and buses) and the software in the form of a subscription service that provides programming information and the ability to encode the data or media streams. A PVR is also referred to as a hard disk recorder (HDR), digital video recorder (DVR), personal video station (PVS), or a personal TV receiver (PTR).

Set-top box 122 as described in FIG. 1 is able to support communication through WAN and LAN connections, Bluetooth, Institute of Electrical and Electronics Engineers (IEEE) 802.11, universal serial bus (USB), 1394, intelligent drive electronics (IDE), peripheral component interconnect (PCI) and infrared. Other interfaces may be added or substituted for those described as new interfaces are developed and according to the particular application for set-top box 122.

Set-top box 122 has a unique IP address that distinguishes it from any other set-top box. Set-top box 122 may also be configured with a cable modem, Wi-Fi capabilities and/or data storage resources.

The relevant contents (forwarded from either satellite dish 120 or CATV network 116) are then displayed via set-top box 122 to the user on television 124 and/or via WAP 126 to one or more of PDA 128, printer 130, laptop computer 132 or desktop computer 134.

The components of voice enabled information retrieval system 102 will now be described with reference to FIG. 2. Referring to FIG. 2, voice enabled information retrieval system 102 includes, but is not necessarily limited to, a search and analysis engine 202, a telephony recognition engine 204, a voice portal 206, a request interpreter engine 208, a distributed speech recognition (DSR) portal 210 and a DSR speech recognition engine 212.

Voice portal 206 receives the user's information request in the form of voice data from PSTN 106 or wireless network 112. Voice portal 206 controls the input and output of telephony recognition engine 204. Telephony recognition engine 204 performs speech recognition for voice portal 206. Voice portal 206 sends the voice data to telephony recognition engine 204 and retrieves the speech recognition result back.

DSR portal 210 receives the user's information request in the form of voice data from wireless network 112. DSR portal 210 controls the input and output of DSR speech recognition engine 212. DSR speech recognition engine 212 performs speech recognition for DSR portal 210. DSR portal 210 sends the voice data to DSR speech recognition engine 212 and retrieves the speech recognition result back.

Both voice portal 206 and DSR portal 210 send the speech recognition result received back from telephony recognition engine 204 and DSR speech recognition engine 212, respectively, to request interpreter engine 208. Request interpreter engine 208 determines the search criteria (e.g., keywords) of the information request based on the speech recognition.

Voice portal 206 and DSR portal 210 then forward the search criteria to search and analysis engine 202. Search and analysis engine 202 uses the search criteria to search data network 114 for appropriate contents that may be relevant to answer the user's information request.

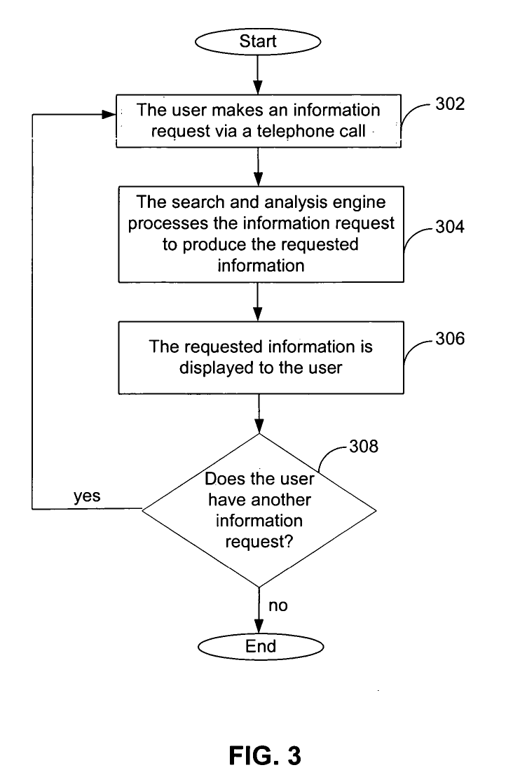

It is to be appreciated that a lesser or more equipped voice enabled information retrieval system 102 than the example described above may be preferred for certain implementations. Therefore, the configuration of system 102 will vary from implementation to implementation depending upon numerous factors, such as price constraints, performance requirements, technological improvements, or other circumstances. Embodiments of the invention may also be applied to other types of software-driven systems that use different hardware architectures than that shown in FIGS. 1 and 2. Embodiments of the operation of the present invention are described next in more detail with reference to the flow diagrams of FIGS. 3-7.

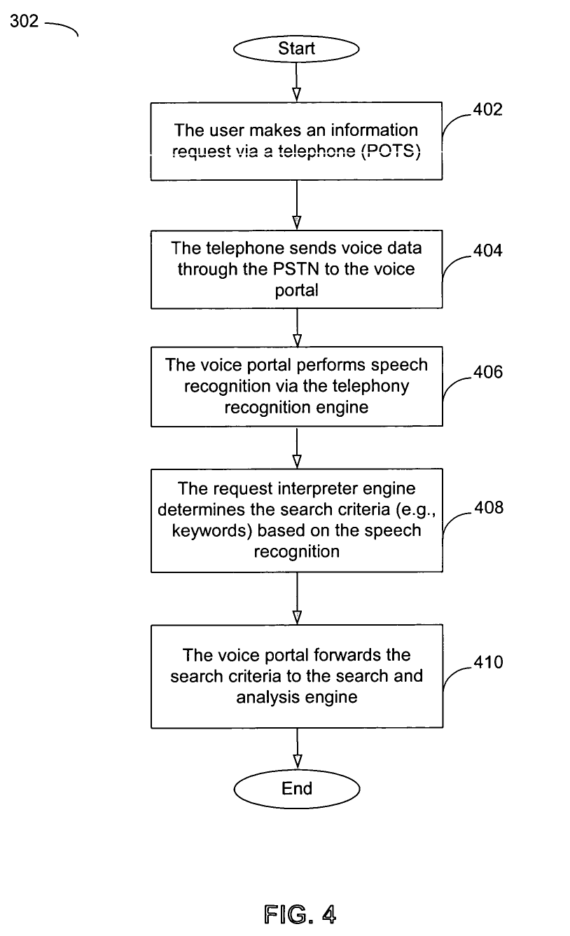

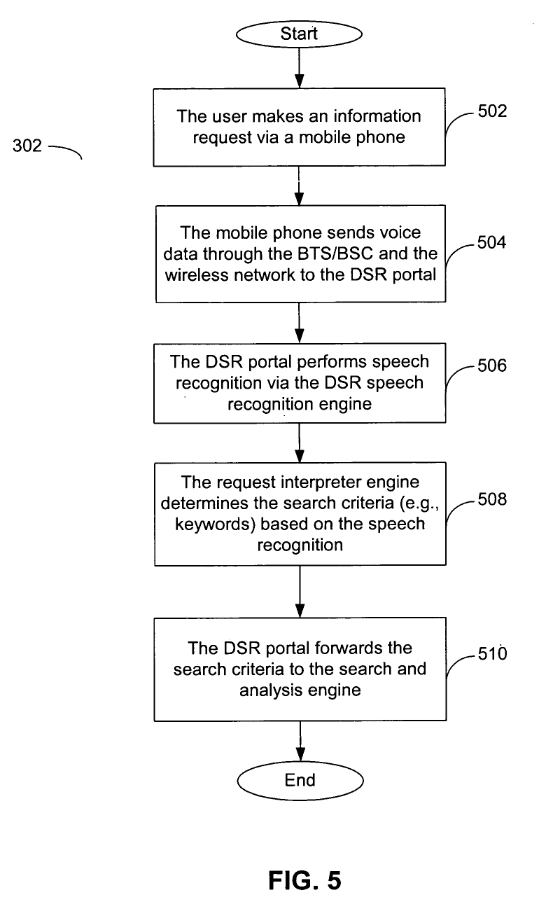

FIG. 3 is a flow diagram of one embodiment of a process for allowing voice enabled information retrieval via a set-top box. Referring to FIG. 3, the process begins at processing block 302 with the user making an information request via a telephone call. An example of such an information request is as follows: “I am looking for homes for sale in the Chicago area between $300,000 and $400,000.” Processing block 302 is described in more detail below with reference to FIGS. 4 and 5.

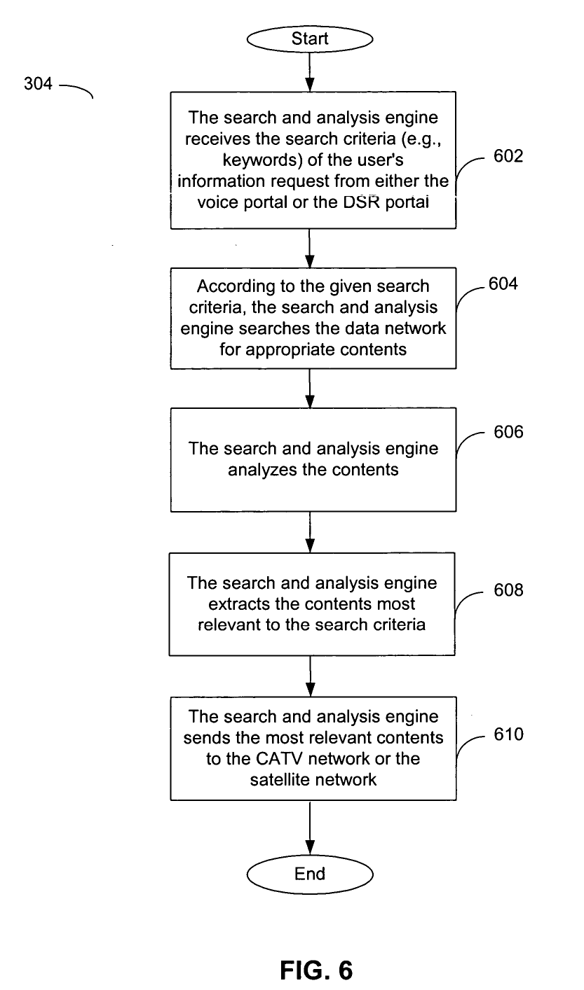

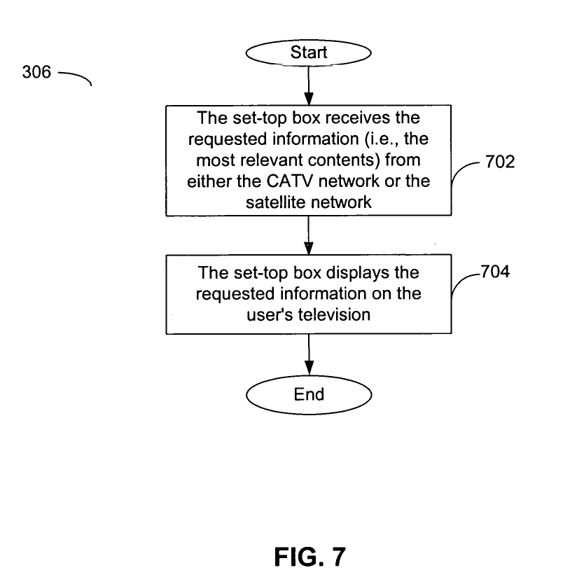

At processing block 304, search and analysis engine 202 processes the user's information request to produce (or extract) the requested information. Processing block 304 is described in more detail below with reference to FIG. 6. At processing block 306, the requested information is displayed to the user. For example, the requested information displayed to the user could be a MLS listing of homes in the Chicago area that are actively on the market and fall within the $300,000 to $400,000 price range. Processing block 306 is described in more detail below with reference to FIG. 7. At decision block 308, it is determined whether the user has another information request. If so, then processing logic proceeds back to processing block 302. Otherwise, the process of FIG. 3 ends.

As described above, in an embodiment of the invention, the voice data travels to voice enabled information retrieval system 102 via telephone 104 and PSTN 106. This embodiment is described with reference to FIG. 4. In another embodiment of the invention, the voice data travels to voice enabled information retrieval system 102 via mobile phone 108, BS/BSC 110 and wireless network 112. This embodiment is described with reference to FIG. 5.

FIG. 4 is a flow diagram of one embodiment of a process for allowing the user to make an information request via a telephone (POTS) (processing block 302 of FIG. 3). Referring to FIG. 4, the process begins at processing block 402 with the user making an information request via telephone 104. Using the same example as above, the information request is as follows: “I am looking for homes for sale in the Chicago area between $300,000 and $400,000.” In processing block 404, telephone 104 sends the voice data (i.e., the information request) to PSTN 106. PSTN 106 forwards the voice data to voice portal 206 of voice enabled information retrieval system 102.

In processing block 406, voice portal 206 performs speech recognition via telephony recognition engine 204. Here, the voice data is transformed into a text format. In processing block 408, voice portal 206 passes the speech recognition (i.e., text) to request interpreter engine 208. Request interpreter engine 208 determines the search criteria (e.g., keywords) based on the speech recognition. For example, the search criteria or keywords may include “homes”, “sale”, “Chicago”, and “price”, “between” “300,000”, and “400,000.” Voice portal 206 then forwards the search criteria to search and analysis engine 202 in processing block 410. The process of FIG. 4 ends at this point.

FIG. 5 is a flow diagram of one embodiment of a process for allowing the user to make an information request via a mobile phone (processing block 302 of FIG. 3). Referring to FIG. 5, the process begins at processing block 502 with the user making an information request via mobile phone 108. In processing block 504, mobile phone 108 sends the voice data (i.e., the information request) to BS/BSC 110, which then forwards the voice data to wireless network 112. Wireless network 112 forwards the voice data to DSR portal 210 of voice enabled information retrieval system 102.

In processing block 506, DSR portal 210 performs speech recognition via DSR speech recognition engine 212. Here, the voice data is transformed into a text format. In processing block 508, DSR portal 210 passes the speech recognition (i.e., text) to request interpreter engine 208. Request interpreter engine 208 determines the search criteria (e.g., keywords) based on the speech recognition. DSR portal 210 then forwards the search criteria to search and analysis engine 202 in processing block 510. The process of FIG. 5 ends at this point.

FIG. 6 is a flow diagram of one embodiment of a process for processing the user's information request to produce the requested information (processing block 304 of FIG. 3). Referring to FIG. 6, the process begins at processing block 602 with the search and analysis engine 202 receiving the search criteria of the user's information request from either voice portal 206 or DSR portal 210. In our example, search and analysis engine 202 receives the keywords “homes”, “sale”, “Chicago”, and “price”, “between” “300,000”, and “400,000.”

In processing block 604, search and analysis engine 202 uses the search criteria to search data network 114 for appropriate contents. In our example, assume data network 114 is the Internet and that search and analysis engine 202 uses the keywords “homes”, “sale”, “Chicago”, and “price”, “between” “300,000”, and “400,000” to do a query search on the Internet. Also assume that the Internet search results in the following contents (or hits): (1) a MLS listing that includes homes for sale in the Chicago city area between the price of $300,000 and $400,000; (2) a MLS listing that includes homes for sale in the Chicago housing development in the state of Florida between the price of $300,000 and $400,000; and (3) a web site for a historic Chicago home that was just renovated for the price of $300,000 and is now for sale for $700,000.

In processing block 606, search and analysis engine 202 analyzes the contents (1)-(3) above. In processing block 608, search and analysis engine 202 extracts the contents most relevant to the search criteria. In our example, search and analysis engine 202 is likely to determine that only content (1) above is relevant to the user's information request (i.e., search criteria). Finally in processing block 610, search and analysis engine 202 sends the most relevant contents to CATV network 116 or satellite network 118. Again in our example, search and analysis engine 202 would send only content (1). The process of FIG. 6 ends at this point.

FIG. 7 is a flow diagram of one embodiment of a process for displaying the requested information to the user (processing block 306 of FIG. 3). Referring to FIG. 7, the process begins at processing block 702 with set-top box 122 receiving the requested information (i.e., most relevant contents) from either CATV network 116 or satellite network 118 (via satellite dish 120). In processing block 704, set-top box 122 displays the requested information on the user's television in one embodiment of the invention. The process in FIG. 7 ends at this time.

There are many ways in which set-top box 122 can receive and display the requested information from either CATV network 116 or satellite network 118. As described above, set-top box 122 has a unique IP address that distinguishes it from any other set-top box. Set-top box 122 may also be configured with a cable modem, Wi-Fi capabilities and/or data storage resources. In one embodiment of the invention, set-top box 122 is configured for the invention such that when the requested information is received via its unique IP address, set-top box 122 automatically switches to a separate CATV independent channel to display the requested information to the user via television 124. In another embodiment of the invention, set-top box 122 may be configured with an USB port and thus can support peripheral devices, such as Wi-Fi storage, to allow a broadband connection to television 124 and the ability to capture and store the requested information. Set-top box 122 may also be programmable and thus is able to receive new firmware loads remotely using its unique IP address and to enable the USB port. Here, if the CATV service provider cannot stream the requested information over a CATV channel, then the user can select a different input (e.g., A/B) for set-top box 122 in order for the requested information to be streamed via the user selected input. Alternatively, if the CATV service provider is able to stream the requested information over a CATV channel, then either a specific and clear channel is reserved at all times to receive the user's requested information or, based on the user's subscription service, set-top box 122 could determine which channel does not receive a signal and display the requested information on that channel.

A method and system for allowing voice enabled information retrieval via a set-top box have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method comprising:
receiving an information request from a user, wherein the information request includes voice data;
searching a data network to extract content based on the information request; and
sending the extracted content to be displayed to the user via a set-top box.

2. The method of claim 1, wherein receiving the information request from the user comprises receiving the information request via a public switched telephone system (PSTN).

3. The method of claim 1, wherein receiving the information request from the user comprises receiving the information request via a wireless network.

4. The method of claim 1, wherein the data network is the Intranet.

5. The method of claim 1, wherein the data network is a searchable medium capable of storing on-line information.

6. The method of claim 1, wherein displaying the extracted content to the user via the set-top box comprises sending the extracted content to the set-top box via a cable television (CATV) network.

7. The method of claim 1, wherein displaying the extracted content to the user via the set-top box comprises sending the extracted content to the set-top box via a satellite network.

8. The method of claim 1, wherein displaying the extracted content to the user via the set-top box comprises displaying the extracted content to one or more of a television, a personal digital assistant (PDA), a printer, a laptop computer and a desktop computer via the set-top box.

9. A system comprising:
a port that receives an information request from a user, wherein the information request includes voice data; and
a search and analysis engine that searches a data network to extract content based on the information request, wherein the search and analysis engine sends the extracted content to be displayed to the user via a set-top box.

10. The system of claim 9, wherein the port receives the information request from the user via a public switched telephone system (PSTN).

11. The system of claim 9, wherein the port receives the information request from the user via a wireless network.

12. The system of claim 9, wherein the data network is the Intranet.

13. The system of claim 9, wherein the data network is a searchable medium capable of storing on-line information.

14. The system of claim 9, wherein the search and analysis engine sends the extracted content via a cable television (CATV) network to be displayed to the user via a set-top box.

15. The system of claim 9, wherein the search and analysis engine sends the extracted content via a satellite network to be displayed to the user via a set-top box.

16. The system of claim 9, wherein the extracted content is displayed to the user via the set-top box via one or more of a television, a personal digital assistant (PDA), a printer, a laptop computer and a desktop computer via the set-top box.

17. A machine-readable medium containing instructions which, when executed by a processing system, cause the processing system to perform a method, the method comprising:
receiving an information request from a user, wherein the information request includes voice data;
searching a data network to extract content based on the information request; and
sending the extracted content to be displayed to the user via a set-top box.

18. The machine-readable medium of claim 17, wherein receiving the information request from the user comprises receiving the information request via a public switched telephone system (PSTN).

19. The machine-readable medium of claim 17, wherein receiving the information request from the user comprises receiving the information request via a wireless network.

20. The machine-readable medium of claim 17, wherein the data network is the Intranet.

21. The machine-readable medium of claim 17, wherein the data network is a searchable medium capable of storing on-line information.

22. The machine-readable medium of claim 17, wherein displaying the extracted content to the user via the set-top box comprises sending the extracted content to the set-top box via a cable television (CATV) network.

23. The machine-readable medium of claim 17, wherein displaying the extracted content to the user via the set-top box comprises sending the extracted content to the set-top box via a satellite network.

24. The machine-readable medium of claim 17, wherein displaying the extracted content to the user via the set-top box comprises displaying the extracted content to one or more of a television, a personal digital assistant (PDA), a printer, a laptop computer and a desktop computer via the set-top box.
